(19) United States
(12) Patent Application Publication
(10) Pub. No.: US 2009/0245549 A1
(43) Pub. Date: Oct. 1, 2009

(54) IDENTIFICATION OF EARBUDS USED WITH PERSONAL MEDIA PLAYERS

(75) Inventors: Matthew Jubelirer, San Diego, CA (US); Carl Joseph Ledbetter, Mercer Island, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/055,312

(22) Filed: Mar. 26, 2008

(51) Int. Cl. H04R 5/02

(52) U.S. Cl. 381/309

(57) ABSTRACT

An arrangement for identifying the left and right earphones in an earphone set is provided in which the acoustically transparent grills positioned over the transducers in the earphones are configured to provide a visual effect that identifies the correct orientation of the earphone set during use by indicating which earphone is intended for which ear. In an illustrative example, the transducer grills on respective left and right earphones are configured with a series of openings that are arranged in a pattern which indicate “L” and “R.” In other illustrative examples, the transducer grills have embossed or molded markings. As an alternative to the “L” and “R” markings, the transducer grills may be configured to convey other information or graphics such as logos.

### BACKGROUND

Portable computing devices including personal media players such as MP3 (Moving Pictures Expert Group, MPEG-1, audio layer 3) players, laptop PCs (personal computers), PDAs (personal digital assistants), mobile phones, smart phones, and similar devices commonly use compact and lightweight headphones, which are often called headphones, headsets, earphones or earbuds, to render voice, audio content, or an audio portion of video to a user. Portable media players typically provide separate left-channel and right-channel signals to the earphones to produce a stereophonic effect. The earphones will have corresponding left-ear and right-ear speaker portions that will typically include markings or designations so that the user may wear the earphones in the correct orientation. Unfortunately, the markings can often be small and hard to see, particularly as many earphones are often compact in size so that they may be placed in the outer portion of the user's ear canal. As a result, users may have difficulty identifying which earphone is intended for which ear.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

An arrangement for identifying the left and right earphones in an earphone set is provided in which the acoustically transparent grills positioned over the transducers in the earphones are configured to provide a visual effect that identifies the correct orientation of the earphone set during use by indicating which earphone is intended for which ear. In an illustrative example, the transducer grills on respective left and right earphones are configured with a series of openings that are arranged in a pattern which indicate “L” and “R.” In other illustrative examples, the transducer grills have embossed or molded markings. As an alternative to the “L” and “R” markings, the transducer grills may be configured to convey other information or graphics such as logos.

Using the visual effect provided by the pattern of openings or the surface effect such as embossing or molding enables the present earphone orientation markings to be much more effective than the markings that are conventionally used. Because the transducer grill is typically the largest substantially flat portion of the earphone, the orientation markings incorporated into the transducer grill can be much larger than conventional markings which are commonly printed on the stem or back portions of the earphone. In addition, the present orientation markings are easy to locate because users will typically look at the transducer grill when preparing to use the earphones since the grill is normally oriented towards the user before the earphone is placed in the ear.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative portable device usage environment where a user listens to audio content or an audio portion of video content that is being rendered through an earphone set by a personal media player;

FIG. 2 shows details of components used in the illustrative earphone set shown in FIG. 1;

FIG. 2A shows a pair of earphones that are magnetically coupled for storage;

FIG. 3 shows enlarged and detailed top, side, back, front, and bottom views of an illustrative earphone;

FIG. 4 shows an isometric view of the illustrative earphone shown in FIG. 3;

FIG. 5 shows a side phantom view of an illustrative transducer that is used in an earphone;

FIG. 6 shows an illustrative earphone as worn in the user's ear;

FIGS. 7 and 8 show front views of alternative earphones configured with transducer grills having different perforation patterns;

FIGS. 9 and 9A show, respectively, illustrative left and right earphones configured with transducer grills that are perforated with openings in patterns which indicate “L” and “R”;

FIGS. 9B and 9C show, respectively, isometric views of the left and right earphones shown in FIGS. 9 and 9A;

FIGS. 10 and 10A show respective front and isometric views of an illustrative earphone having a transducer grill that is perforated with openings in a pattern of a logo;

FIGS. 11 and 11A show respective isometric views of illustrative left and right earphones where the transducer grills are configured from screen materials and include openings which indicate “L” and “R”; and

FIGS. 12 and 12A show respective isometric views of illustrative left and right earphones where the transducer grills include “L” and “R” which are embossed on the transducer grills.

Like reference numerals indicate like elements in the drawings. Elements are not drawn to scale unless otherwise indicated.

### DETAILED DESCRIPTION

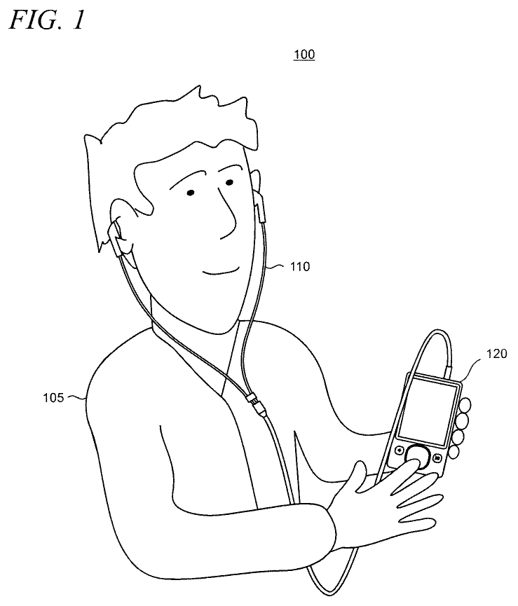

FIG. 1 shows an illustrative portable device usage environment 100 where a user 105 listens to audio content being rendered through a set of earphones 110 by a personal media player 120. In this example, the personal media player 120 is representative of the popular players available on the market that can play audio content like MP3 files or content from over the air radio stations, and also display video and photographs, or render other content.

However, the present arrangement for identifying earphones may also be utilized with a wide variety of media rendering devices that use earphones. Such devices include laptop PCs, PDAs, handheld game devices, mobile phones, smart phones, and other similar devices. Such devices are typically portable and powered by batteries that are generally rechargeable when connected to an external power supply.

The earphone set 110 is representative of a class of devices used to render audio which may also be known as headphones, earbuds, headsets, and by other terms. The earphone set 110 generally will be configured with a pair of audio speakers, along with a means to position the speakers close to the user's ears. Some earphone designs place the speakers in pads that sit around or on the ear. Other designs place the speaker immediately adjacent to the outer portion of the user's ear canal. These designs are typically compact and lightweight and are often sold and used with personal media players. It is noted that to avoid ambiguity among commonly used terms, the term “earphone set” is used here to refer to a complete set of earphones which includes the audio speakers, cables, plug, and other related components. The term “earphones” is used to refer to those components of the earphone set that are positioned near the user's ears when the earphones are in use.

The user 105 typically uses the earphone set 110 to enable audio content such as music to be consumed privately (i.e., without the audio content being heard by others) and at volume levels that are satisfactory for the user while maintaining good battery life in the device. In some cases, the earphone set 110 will also incorporate a microphone to enable the user's voice and other sounds to be picked up, for example, when the earphones/microphone combination is used in conjunction with a mobile phone.

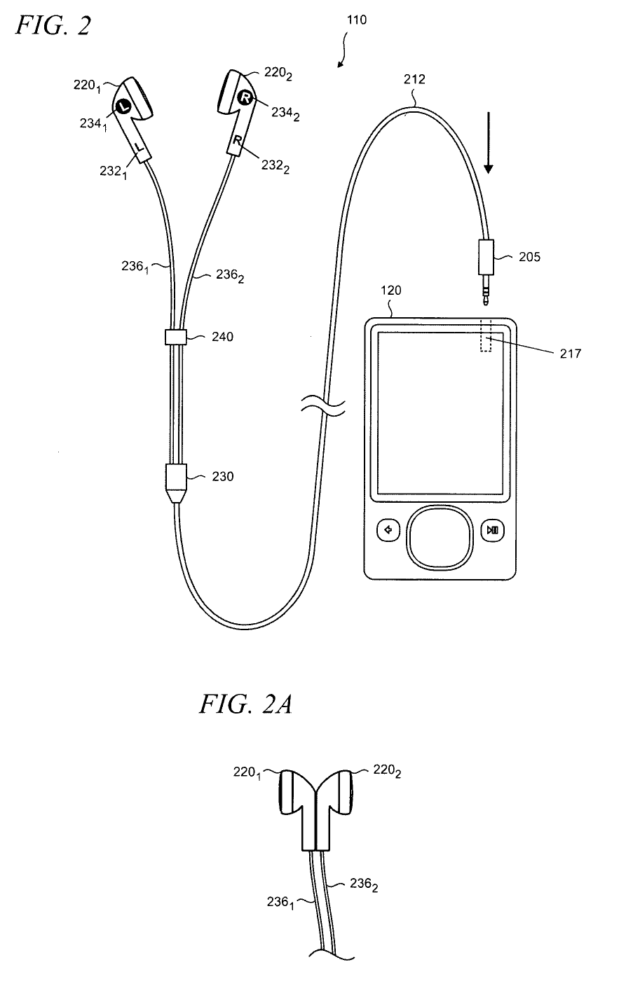

FIG. 2 shows details of components used in the portable media player 120 and earphone set 110. The earphone set 110 is mechanically and operatively coupled to the media player 120 with a plug 205 that is located at the distal end of a single cable 212. Plug 205 interfaces with a mating jack 217 that is disposed on a top surface of the personal media player 120, in this example, so that an audio output signal generated by the player 120 may be rendered by the earphones 220₁ and 220₂. Typically, the output is a stereophonic signal that produces a stereo effect for the user 105 when rendered by the earphones 220. Accordingly, the earphones 220 are generally identified as being either intended for the right or left ear of the user 105.

In FIG. 2, the earphones 220 are shown with conventional markings such as lettering “L” and “R” to identify the correct orientation of the earphone set 110 when used. A variety of techniques are commonly used to mark earphones when they are manufactured. For example, lettering can be applied using pad printing, silk screening, and other conventional printing techniques. And, as the earphones 220 are commonly formed from plastic materials at least in part, the lettering may be molded into a portion of the earphones, for example as raised or recessed markings. In this example, “L” and “R” markings, 232₁ and 232₂ respectively, are located on the stem portions of the earphones. Other locations may alternatively be used for the markings as well. For example, white “L” and “R” markings, 234₁ and 234₂ respectively, shown on a dark background, are located on a hemispherically shaped transducer (i.e., speaker) housing portion of the earphones 220.

The proper orientation of the earphones 220 during use is generally important for several reasons. First, the audio content being rendered through the earphones is typically encoded with stereophonic, binaural, or other spatial effects. In order to maintain the correct soundstage as the content producer intended, the correct left-right orientation must be maintained since the left channel and right channels of the content do not typically contain identical audio information. For example, if the audio content accompanies a video playing on the media player 120 and the rendered scene includes a racing car that is driving by from left to right on the screen, the audio should also pan from left to right in order for the user to enjoy the scene as the producer intended.

A second reason for identifying and maintaining the correct orientation of the earphones 220 during use is that not all earphone sets are symmetric. In theses case, the earphone set designer will typically configure a specific earphone 220 to fit a specific ear. Here, the earphone designed for the left ear will not fit the right ear as intended, and vice versa, and using an earphone with the wrong ear can degrade sound quality and performance, for example, by not allowing an effective coupling to occur between the speaker or transducer in the earphone and the user's ear.

The single cable 212 runs between the plug 205 and a splitter 230. The splitter 230 is generally arranged from a resilient and durable material such as molded polymer which is intended to protect the junction point where the single cable 212 splits into individual cables 236₁ and 236₂ which respectively are coupled to the earphones 220₁ and 220₂. Accordingly, the single cable 212 which carries both left and right channels of the stereophonic signal will have twice the number of signal conductors as the individual cables 236 which carry either the left or right channel of the stereophonic signal in most implementations.

While the earphone set 110 shown in FIGS. 1 and 2 uses cables 212 and 236 to carry the signals from the personal media player 120 to the earphones 220, it is noted that the present arrangement for earphone identification may also be applied to wireless earphone and headphone sets. Such equipment commonly uses RF (radio frequency) protocols such as Bluetooth to transport the signals wirelessly. In this case, a Bluetooth transmitter is used which interfaces with the personal media player 120 with either the jack 217 or with a proprietary connector on the player. Such proprietary connectors are also generally utilized for data synchronization with a PC and for receiving power to charge the player's internal battery. A corresponding Bluetooth receiver in the wireless earphone set receives the transmitted signal which can then be rendered by the earphones, typically after being amplified by an onboard amplifier.

Between the splitter 230 and the earphones 220 is a slider 240. Slider 240 enables a user to adjust the point where the individual cables 236 are separated which is helpful to manage the effective lengths of the individual cables, for example, when adjusting the earphone set 110 to fit the user 105 comfortably.

In this example, the earphones 220₁ and 220₂ are configured with respective magnetic elements (not shown) that are positioned along the backs of the stem portions. The magnetic elements have their poles aligned in such a way that the earphones 220 become magnetically coupled when in contact, as shown in FIG. 2A. Such magnetic coupling may help to keep the earphone set 110 organized and tangle-free when stored.

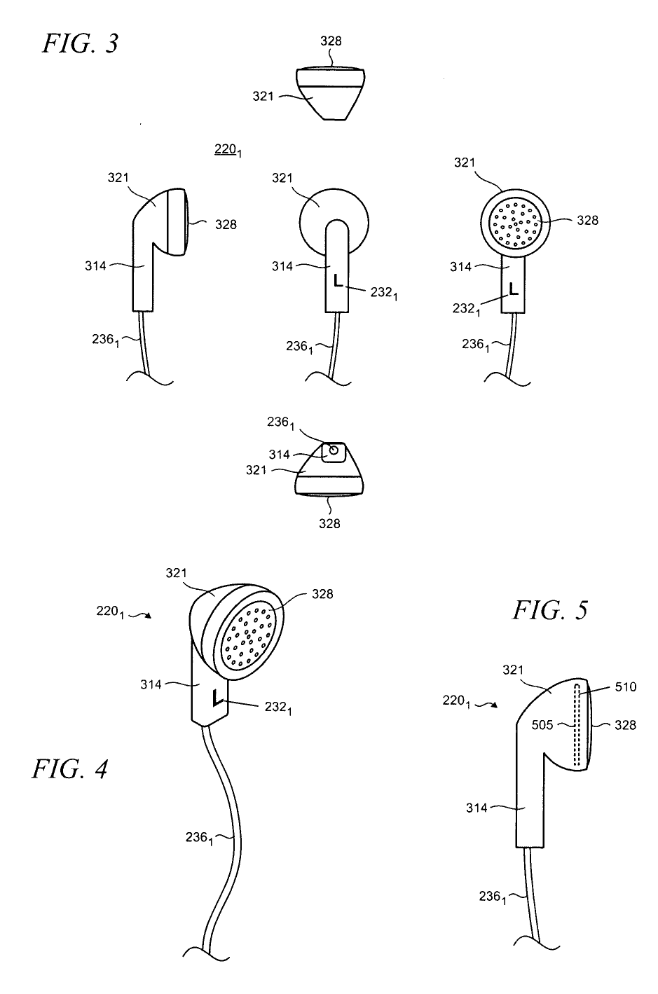

FIGS. 3 and 4 provide views of the left earphone 220₁ that show additional details. As shown, the earphone 220₁ includes a stem 314 that normally projects substantially downward from a transducer housing 321 when the earphone is oriented in normal use. The transducer housing 321 is arranged, in this example, with a substantially hemispherical shape. A transducer grill 328 is located at the larger end of the transducer housing 321. The transducer grill 328 is shown in this example to be conventionally configured for acoustic transparency by being, for example, perforated with openings, or formed from a mesh or screen material. FIGS. 3 and 4 also show several alternative locations for the conventional markings 232₁ on either side of the stem 314.

As shown in FIG. 5, the transducer housing 321 is configured to enclose an audio transducer 505. The audio transducer 505 is coupled to the signal wires (not shown in FIG. 5) contained in the cable 236₁. The audio transducer 505 may be selected from one of a variety of conventional types including, for example, electromagnetic, piezoelectric, electrostatic, or a combination thereof, or from other known types of speakers or drivers that can produce sound waves from an output face 510. The transducer 505 converts the electrical signal received from the media player 120 to an audio signal that is directed through the transducer grill 328.

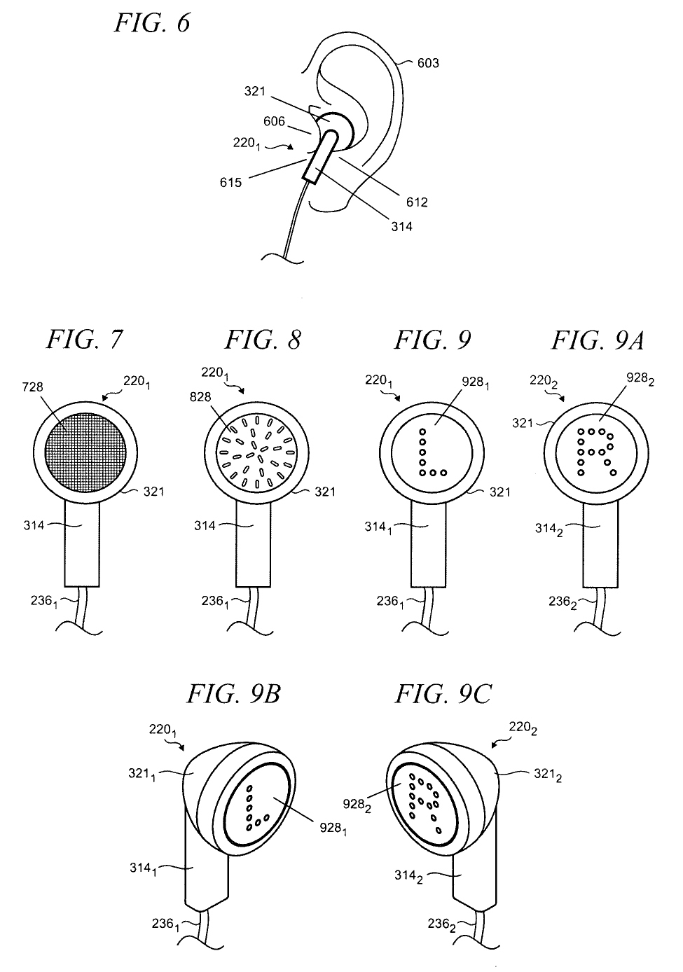

The transducer housing 321 is sized and shaped to fit in a recess (called the lower concha) in the user's ear 603, as shown in FIG. 6, to position the transducer grill adjacent to the ear canal. The rounded convex surface of the transducer housing 321 contacts the tragus 606 and anti-tragus 612 of the ear 603 and the stem 314 extends along the intertragic notch 615 of the ear. The size and shape of the transducer housing 321 and stem 314 enable the earphone 220₁ to be well coupled to the ear canal to render clear sound transmission while fitting in the ear 603 in a secure and stable manner.

As shown in FIGS. 7 and 8, a variety of materials and production techniques may be utilized to provide the transducer grill 328 with acoustic transparency so that the sound waves generated by the transducer 505 can travel without being significantly impeded to the canal of the user's ear 603. In FIG. 7, a screen 728 or mesh type configuration is utilized. Such screen may be fabricated from woven wire materials, for example. FIG. 8 shows a grill 828 that includes a plurality of openings where each of the openings is arranged as a slot with rounded ends.

In accordance with the principles of the present earphone identification arrangement, the techniques that enable acoustic transparency are also utilized to identify the left-ear and right-ear earphones 220. As shown in FIGS. 9 and 9A, the transducer grills 928₁ and 928₂ are respectively perforated with openings in patterns to indicate “L” and “R.” FIGS. 9B and 9C show the earphones 220 in an isometric view. Aside from the transducer grills 928 having the patterned openings, the earphones 220 are configured as shown in the preceding drawings and described in the accompanying text.

Alternative markings may also be utilized. In addition to the uppercase letters “L” and “R” shown in the drawings, lower case letters “l” and “r” may be used, or a mix of upper and lower cases letters may be employed. The entire words “left” and “right” (in uppercase, lowercase, or a combination of both) may be spelled out, or other words or abbreviations may be utilized.

In addition, in some implementations, it may be desirable to indicate the proper orientation of the earphone set 110 for the user by only marking a single earphone 220. For example, the left earphone 220₁ may include openings in the pattern of an uppercase “L” or lowercase “l” while the right earphone 220₂ uses a conventional pattern of openings (e.g., as shown in FIG. 4). Marking the single earphone 220₁ as the earphone for the user's left ear, in this example, still enables the proper orientation of the earphone set 110 to be indicated because the unmarked earphone is implicitly designated for use with the user's right ear.

Although the openings are shown with a circular shape in the drawings, it is emphasized that other shapes and combinations of shapes may also be used. In addition, while not shown, other openings may also be utilized in the transducer grills 928 that are in addition to the openings that form the letters. For example, the openings forming the patterns for the lettering may be larger and have a different shape compared with the supplemental openings. In this way, a variety of opening configurations may be utilized while still allowing a user to discern the “L” and “R” identification markings.

It is also emphasized that the use of “L” and “R” markings are illustrative and that other markings may be used to indicate the orientation of the earphone set 110. For example, other appropriate letters or symbols may be used on the transducer grills 928 of the earphones 220 to tailor the earphone set 110 to local/regional conditions for sale in countries where languages other than English are used. Non-language-based communication graphics or icons, such as arrows, may also be utilized to indicate orientation or provide other information to the user.

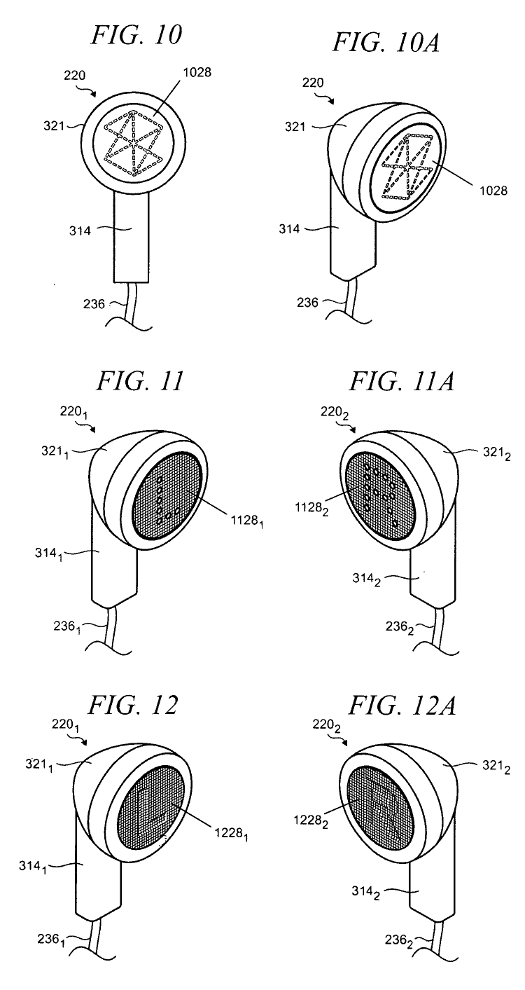

The openings in the transducer grill may be arranged in other patterns besides letters, such as logos, symbols, emblems, or other graphical elements. For example, FIGS. 10 and 10A show respective front and isometric views of the earphone 220 that is configured with an alternative transducer grill 1028 that is perforated with openings in a pattern of a logo. In this example, the pattern is evocative of the logo for Microsoft's Zune brand of personal media players.

The openings which form the patterns of “L” and “R” in the illustrative example shown in FIGS. 9 and 9A-C may also be applied to other transducer grill configurations. For example, as shown in FIGS. 11 and 11A, the transducer grills 1128 are configured using a metal mesh. The mesh includes openings in the patterns of “L” and “R” as shown. As with the previous illustrative example, the openings may be configured in other patterns using symbols, uppercase and lowercase letters, or combinations thereof, in English as well as other languages.

Other finishing techniques may also be used to mark the transducer grills of the earphones 220. For example, as shown in FIGS. 12 and 12A the “L” and “R” markings are embossed onto the screen material of the transducer grills 1228. This technique allows the markings to be either raised over or recessed from the surrounding areas of the transducer grill. Alternatively, in implementations where the transducer grill is formed from a polymer material, the “L” and “R” markings may be molded into the surface of the grill. As with the previous illustrative examples, the markings may be configured using a variety of symbols, uppercase and lowercase letters, or combinations thereof, in English as well as other languages.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An earphone arranged for use with an earphone set having capability to render an audio signal having a left channel and a right channel, comprising:
a transducer housing configured for housing an audio transducer and for orienting the transducer proximate to an ear canal of a user when the earphone is placed adjacent to the ear; and
a transducer grill coupled to the transducer housing to cover an output face of the transducer and being located between the transducer and the ear canal when the earphone is placed adjacent to the ear, the transducer grill being configured for acoustic transparency using a plurality of openings, the openings being configured in a pattern to indicate a left and right orientation for the earphone set so that the left channel is heard by the user's left ear, and the right channel is heard by the user's right ear when the earphone set is used.

2. The earphone of claim 1 in which the pattern is shaped as a letter “L” or a letter “R” in the English language alphabet.

3. The earphone of claim 1 in which the pattern is shaped as a letter in a non-English language which corresponds to either a letter “L” or a letter “R” in the English language alphabet.

4. The earphone of claim 1 in which the pattern is shaped as one of a logo, an emblem, a symbol, or a graphical element.

5. The earphone of claim 1 in which the transducer housing is shaped at least in part substantially as a sphere that is truncated about its equator and the transducer grill is disposed along a plane of the truncation.

6. The earphone of claim 5 in which the transducer housing is sized for fitment within a lower concha of the user's ear when the earphone set is used.

7. The earphone of claim 6 in which the transducer housing is further configured so that hemispherical portions of the housing contact the tragus and anti-tragus of the user's ear when the earphone set is used.

8. The earphone of claim 1 in which the transducer comprises a driver selected from one of electromagnetic driver, piezoelectric driver, electrostatic driver, or a combination thereof.

9. The earphone of claim 1 further comprising a stem portion, a proximal end of the stem portion being fixedly coupled to the transducer housing and a distal end of the stem portion being configured for receiving a cable containing signal conductors for either the left channel or the right channel.

10. An earphone arranged for use with an earphone set having capability to render an audio signal having a left channel and a right channel, comprising:
a transducer housing configured for housing an audio transducer and for orienting the transducer proximate to an ear canal of a user when the earphone is placed adjacent to the ear; and
a transducer grill coupled to the transducer housing to cover an output face of the transducer and being located between the transducer and the ear canal when the earphone is placed adjacent to the ear, the transducer grill being formed from an acoustically transparent material, and the transducer grill further being shaped to indicate a left and right orientation for the earphone set so that the left channel is heard by the user's left ear, and the right channel is heard by the user's right ear when the earphone set is used.

11. The earphone of claim 10 in which the shaping comprises a letter “L” or a letter “R” in an English language alphabet.

12. The earphone of claim 11 in which the letter “L” or the letter “R” is formed using a raised surface on the transducer grill.

13. The earphone of claim 11 in which the letter “L” or the letter “R” is formed using a recessed surface of the transducer grill.

14. The earphone of claim 10 in which the acoustically transparent material is one of mesh or screen.

15. The earphone of claim 14 in which the acoustically transparent material is woven.

16. The earphone of claim 10 in which the shaping is imparted to the transducer grill through an embossing process.

17. The earphone of claim 10 in which the shaping is imparted to the transducer grill using a molding process.

18. An earphone set with capability to render an audio signal having a left channel and a right channel, comprising:
a pair of earphones, each earphone in the pair including i) a transducer housing configured for housing an audio transducer and for orienting the transducer proximate to an ear canal of a user when the earphone is placed adjacent to the ear, and ii) the transducer grill being configured for acoustic transparency using a plurality of openings, the openings being configured in a shape of an “L” or an “R” for marking a left to right orientation for the earphone set so that the left channel is heard by the user's left ear, and the right channel is heard by the user's right ear when the earphone set is used;
a pair of individual cables coupled at their proximal ends to respective ones of the pair of earphones, each cable containing signal conductors for the respective left channel and right channel of the audio signal; and
a plug coupled to the signal conductors and being arranged for interfacing with a corresponding jack in an audio source device.

19. The earphone set of claim 18 further comprising a single cable that is configured to contain the left channel and right channel conductors, the single cable running between the plug and the splitter disposed at the distal ends of the pair of individual cables.

20. The earphone set of claim 18 in which the left channel and right channel are channels of a stereophonic signal or a binaural signal.
